(19) United States
(12) Patent Application Publication
(10) Pub. No.: US 2022/0036283 A1
(43) Pub. Date: Feb. 3, 2022

(54) METHOD AND TECHNICIAN ALLOCATING SYSTEM FOR ALLOCATING A FIELD TECHNICIAN

(71) Applicant: Telefonaktiebolaget LM Ericsson (publ), Stockholm (SE)

(72) Inventors: Rafia INAM, VÄSTERÅS (SE); Yifei JIN, SOLNA (SE); Aneta VULGARAKIS FELJAN, STOCKHOLM (SE); Daniel LINDSTRÖM, LULEÅ (SE); Jörg NIEMÖLLER, SOLLENTUNA (SE); Bin SUN, LULEÅ (SE)

(21) Appl. No.: 17/299,262

(22) PCT Filed: Dec. 5, 2018
(86) PCT No.: PCT/EP2018/083582

§ 371 Date: Jun. 2, 2021

(51) Int. Cl. G06Q 10/06; G06F 16/2457; H04L 12/24; G06Q 50/32

(52) U.S. Cl. CPC G06Q 10/063112; G06Q 50/32; H04L 41/147; G06F 16/24578

(57) ABSTRACT

A method performed by a technician allocation system for allocating a field technician is provided. The technician allocation system identifies features f_1 . . . f_(n) of a received new work order to be executed. The technician allocation system then obtains a similarity score for the identified features f_1 . . . f_n, wherein the similarity score is related to how similar the new work order is to previously executed old work orders with respect to the identified features. The technician allocation system also obtains a field technician experience score for the identified features f_1 . . . f_n. The technician allocation system then matches the field technician candidates with the features f_1 . . . f_n for the new work order based on the obtained field technician experience scores and the similarity scores.

### TECHNICAL FIELD

The present disclosure relates generally to a method and a technician allocating system for the allocating of a field technician for executing a new received work order on equipment in a communication network.

### BACKGROUND

Communication networks of today, such as wireless networks, are typically very complex and contain many different nodes, elements and components, herein generally referred to as “equipment”, which are used to provide various communication services for users and subscribers and also for monitoring and surveillance of the network and its performance. Due to the complexity and many parts of such a communication network, various problems and issues are bound to occur in the network from time to time which often require some appropriate action by a field technician, e.g. on site, to remedy or repair the problem or issue. A problem in the network may involve faulty equipment, which may include both software equipment and hardware equipment, that needs to be attended to, such as repaired, restored, replaced or upgraded, in order to eliminate or at least somehow address the problem.

When such a problem or issue is detected in a communication network, a work order is generated to address the problem and it is necessary to allocate a hopefully competent person to execute the work order, often locally on site where the cause for the problem or issue is known or assumed to be located. Such a person is commonly referred to as a field technician which term will be used in this description. The work order may comprise one or more specific tasks which effectively define the work order and there are typically a plurality of field technicians available for execution of various work orders in the network.

However, the allocation of a suitable field technician may not be optimal and it typically requires a certain amount of manual actions which must be made to obtain information about suitability of a number of candidate field technicians. A field technician is then selected to execute the work order based on whatever information that could be obtained, although without being confident as to whether the selected person is really able to execute the work order successfully. In practice, field technicians are typically selected by a person purely based on availability without consideration of their skills.

### SUMMARY

It is an object of embodiments described herein to address at least some of the problems and issues outlined above. It is possible to achieve this object and others by using a method and a technician allocating system as defined in the attached independent claims.

According to one aspect, a method, which may be performed by a technician allocating system which operates in a telecommunication network, is provided for allocating a field technician (FT). The technician allocation system identifies features f₁ . . . fₙ of a received new work order (WO) to be executed on equipment in the telecommunication network. The technician allocation system obtains similarity scores for the identified features f₁ . . . fₙ, wherein the similarity scores are related to how similar the new WO is to previously executed old WOs with respect to the identified features, the old WOs having at least one of the features f₁ . . . fₙ. The technician allocation system also obtains for a set of FT candidates, a FT experience score for each FT candidate with respect to the identified features f₁ . . . fₙ. The technician allocation system then matches the FT candidates with the features f₁ . . . fₙ for the new WO based on the obtained FT experience scores and the similarity scores and allocates at least one of the FTs for executing the new WO on said equipment, based on the matching.

According to another aspect, a technician allocating system is arranged to allocate a FT. The technician allocation system operates in a telecommunication network. The technician allocation system is configured to:
Identify features f₁ . . . fₙ of a received new WO, to be executed on equipment in the telecommunication network.
Obtain similarity scores for the identified features f₁ . . . fₙ, wherein the similarity scores are related to how similar the new WO is to previously executed old WOs with respect to the identified features, the old WOs having at least one of the features f₁ . . . fₙ.
Obtain for a set of FT candidates, a FT experience score for each FT candidate with respect to the identified features f₁ . . . fₙ.
Match the FT candidates with the features f₁ . . . fₙ for the new WO based on the obtained FT experience scores and the similarity scores.
Allocate at least one of the FTs for executing the new WO on said equipment, based on the matching.

A computer program is also provided comprising instructions which, when executed on at least one processor in the above technician allocating system, cause the at least one processor to carry out the method described above. A carrier is also provided which contains the above computer program, wherein the carrier is one of an electronic signal, an optical signal, a radio signal, or a computer readable storage medium.

The above method and technician allocating system may be configured and implemented according to different optional embodiments to accomplish further features and benefits, to be described below.

As the allocation is largely automated to decrease human involvement, a more accurate and efficient allocation procedure is provided which may avoid inadequate visits to equipment sites.

Another advantage of embodiments herein is that FT novices may be identified and trained more efficiently and build expertise on dispatch needs.

Another advantage of embodiments herein is that expert groups for cross-region/disaster assistance may be quickly assembled. Sometimes very special skills or special-trained FTs are needed to deal in disastrous situations, such as fixing a site that is damaged by an earth quake. It is hard to manually find a FT for a network operations center (NOC). Embodiments herein will make it easier. Another advantage of embodiments herein is that a skill database from both individual and regional perspective is continuously updated/optimized. Another advantage of embodiments herein is the improved managing knowledge concerning local field service operation (FSO) specialty (fault concerning local climate, traffic routine and etc.).

### BRIEF DESCRIPTION OF DRAWINGS

The solution will now be described in more detail by means of exemplary embodiments and with reference to the accompanying drawings, in which:

FIG. 1 illustrates a communication scenario where a procedure for allocating a field technician is employed, according to some example embodiments.

FIG. 2 is a flow chart illustrating a procedure that may be performed by a technician allocation system, according to further example embodiments.

FIG. 3 is a flow chart showing an example of how a field technician experience score may be obtained, according to further example embodiments.

FIG. 4 is a schematic block diagram illustrating hierarchical clustering of working orders according to further example embodiments.

FIG. 5 is a schematic block diagram illustrating how field technicians are linked to executed work orders according to further example embodiments.

FIG. 6 is a block diagram illustrating how a technician allocating system may be structured, according to further example embodiments.

### DETAILED DESCRIPTION

Embodiments herein are based on the insight that by using a technician allocating system that operates based on previously recorded pairs of WOs and FTs, the system may learn, for example, how much time it took to solve a particular WO and which FT profile that was used to solve it. This type of information can be accessed from a database or the like, as a basis for FT allocations. The technician allocating system may then propose future FT allocations and thereby assist the dispatch center, such as the network operations center, in allocating the most suitable field technician to execute a specific work order.

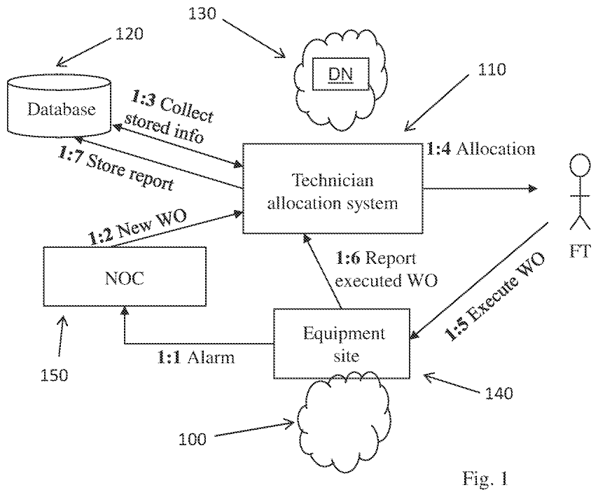

With reference to FIG. 1, a communication scenario is shown where a procedure for allocating a FT is employed, according to some example embodiments. When a problem or issue is detected in an equipment site 140 in a telecommunication network 100, an alarm is generated and sent from the equipment site 140 to a network operations center (NOC) 150, action 1:1. The NOC 150 then issues a WO, herein denoted “new WO”, to the technician allocating system 110 basically as a request to allocate a suitable FT to solve the problem, action 1:2. The new WO may contain information about the problem or issue to be solved and also some background information, which background information may include e.g. which location the problem is detected at or which equipment that is needed to solve the problem. Each of these types of information corresponds to an identified feature of the WO.

The technician allocation system 110 then collects stored information from a database 120, which may include information about previous executed WOs, herein denoted “old WOs”, and information about the expertise of a set of candidate FTs, action 1:3. This information may be stored in the form of a tree structure in the database 120, to be described further below. The stored information may be used to obtain similarity scores of the identified features of the new WO. The similarity scores are related to how similar the new WO is to previously executed old WOs with respect to the identified features, the old WOs having at least one of the features that were identified in the new WO. Such a similarity score may thus be obtained for each relevant old WO in comparison with the new WO.

The stored information in the database 120 may also be used to obtain, for a set of FT candidates, a FT experience score for each FT candidate with respect to the identified features of the WO. The FT experience scores are dependent on the number of times the respective FT candidate has executed an old WO having at least one of the features of the WO. The similarity scores and the FT experience scores are then used to match the FT candidates to the new WO.

At least one of the FT candidates is then allocated for executing the WO, action 1:4. The allocated FT is then accordingly dispatched to execute the WO at the equipment site 140 where the problem was detected, action 1:5. After the FT has executed the WO, the FT provides details of the work of the executed WO and reports this to the technician allocation system 110, action 1:6, which stores the information of the executed WO in the database 120, action 1:7. The procedure for allocating a FT will be further described below.

By storing information of the FTs expertise/features in the database 120 when a WO has been executed, the FTs may be linked to specific relevant types of WOs. And based on this information the most suitable FT can be automatically allocated by the technician allocation system 110 without the need for any manual involvement.

Example embodiments of a method for allocating a FT will now be described and explained in terms of functionality in a technician allocation system 110 which operates in a telecommunication network 100.

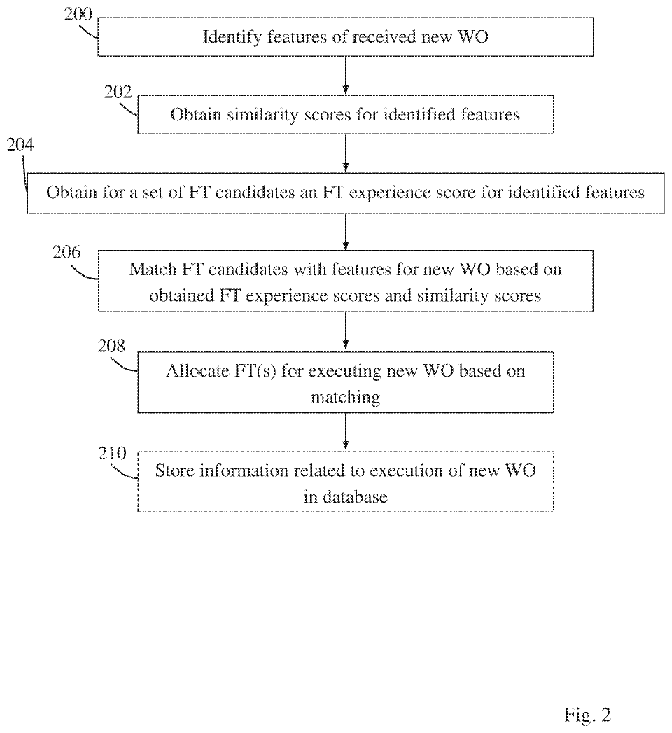

An example of how the method may be employed in terms of actions performed by the technician allocation system 110 is illustrated by the flow chart in FIG. 2 which will now be described with further reference to FIG. 1, although this procedure is not limited to the example of FIG. 1. The actions in FIG. 2 may be taken in any suitable order. FIG. 2 thus illustrates a procedure in the technician allocation system 110 for allocating a FT. Some optional example embodiments that could be used in this procedure will also be described. Actions that are optional are presented in dashed boxes.

A first action 200 illustrates that the technician allocation system 110 identifies features f₁ . . . fₙ of a received new work order (WO) to be executed on equipment in the telecommunication network 100. Equipment may be both software equipment and hardware equipment such as different nodes, elements and components, etc. used in the telecommunication network 100.

In another action 202, the technician allocation system 110 further obtains a similarity score for the identified features f₁ . . . fₙ, e.g. from a database 120, wherein the similarity score is related to how similar the new WO is to previously executed old WOs with respect to the identified features, the old WOs having at least one of the features f₁ . . . fₙ. Action 202 corresponds to action 1:3 of FIG. 1.

The technician allocation system 110 may further obtain for a set of FT candidates, an FT experience score for the identified features f₁ . . . fₙ, e.g. from the database 120, as shown in action 204 likewise corresponding to action 1:3.

In another action 206, the technician allocation system 110 matches the FT candidates with the features f₁ . . . fₙ for the new WO based on the obtained FT experience scores and the similarity scores.

In a further action 208, the technician allocation system 110 allocates at least one of the FT candidates for executing the new WO on said equipment, based on the matching, as also shown in action 1:4 of FIG. 1.

In one example embodiment, another action 210 illustrates that, after execution of the new WO by the at least one allocated FT, the technician allocating system 110 may store information related to said execution in a database 120 as a basis for updating a FT experience score of the at least one allocated FT, as also shown in action 1:7 of FIG. 1.

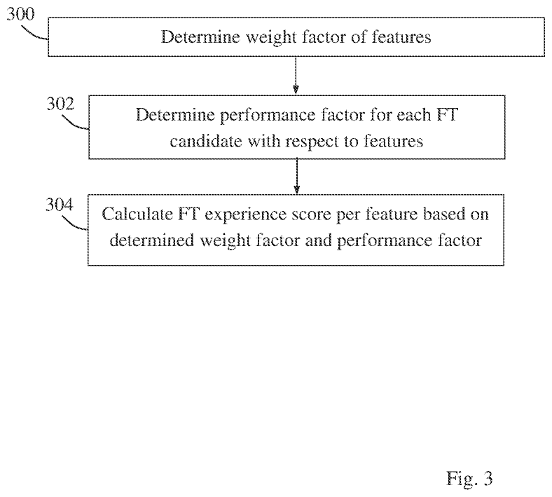

An example of how action 204 could be performed will now be described in more detail with reference to the flow chart in FIG. 3 and with further reference to FIG. 1, although this procedure is likewise not limited to the example of FIG. 1.

In one example embodiment, illustrated by action 300, when obtaining the FT experience score the technician allocating system 110 may determine a weight factor of the features f₁ . . . fₙ indicating the number of times the FT has executed the old WO.

In another example embodiment, illustrated by action 302, when obtaining the FT experience score the technician allocating system 110 may further determine a performance factor for each FT candidate with respect to the features f₁ . . . fₙ, wherein the performance factor is related to a result when the old WO was executed by the FT, as also shown in action 1:3 of FIG. 1

In one example embodiment, action 304, when obtaining the FT experience score the technician allocating system 110 may eventually calculate the FT experience score per feature based on the determined weight factor and performance factor, as also shown in action 1:3 of FIG. 1.

As an alternative, a Distributed Node DN and functionality, e.g. comprised in a cloud 130 as shown in FIG. 1 may be used for performing or partly performing the various actions described herein.

An advantage of a cloud implementation of embodiments herein is that data may easily be shared between different technician allocating systems by accessing the cloud.

An advantage with the embodiments herein is that as the technician allocation system is automated, the most suitable FT in a particular situation may be allocated. This automation brings benefits of best possible solutions in less time and effort.

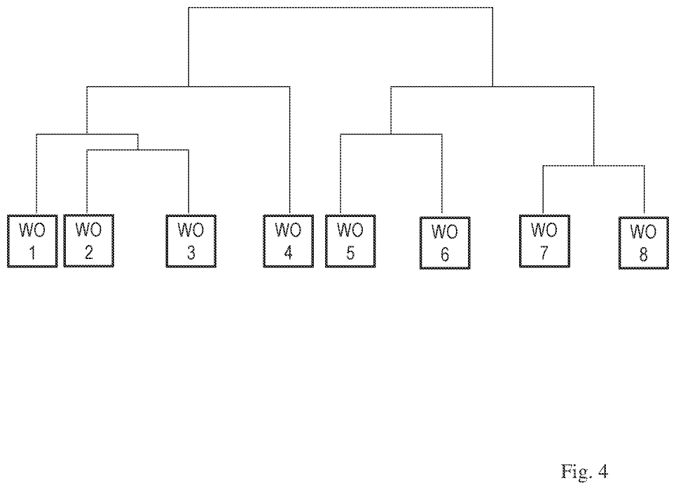

A schematic block diagram illustrating hierarchical clustering of WOs according to further example embodiments is illustrated in FIG. 4. A WO is usually rich in information about the problem to be solved and its context and conditions. Most of this information is typically indicated in the alarm description, e.g. as of action 1:1. The problem description may contain certain keywords that indicate the type of problem. The contextual information may contain the location, type of node to be serviced and indicate equipment needed for the executing the WO. Each type of information is a feature of the WO. The set of features of a WO may constitute its individual profile.

When a FT has executed a WO, the FT provides some details of the work that has been performed. These details of the work may include: the FSO result, time consumed in executing the WO, used tools such as (Site Master, 4×4 cars, climbing equipment, FSO Tool start kit), product vendor, site manager, accessibility, SLA status, etc. Furthermore, this information may be added to the feature set of the WO.

All historical work orders may be organized in a tree structure as shown in FIG. 4, and hierarchical clustering, e.g. Bisecting K-means (BK-means), may be used. BK-means when used herein is a hierarchical clustering algorithm that applies a top-down clustering procedure. If efficiency is more preferred than accuracy, BK-means has the advantage of being able to perform early-stops to build a non-complete tree and consider non-separated WOs within an arbitrary leaf as a single WO to conduct the calculation to save time. The tree structure mentioned herein could also be referred to as a tree graph or just tree for short, and these terms are used interchangeably herein. The tree may be built based on the features from the alarm description. The clustering may be cut from any level on the tree, e.g. from the bottom level which means that one node with one WO forms one cluster. However, any number of WOs may form and be comprised in a cluster. A new WO is allocated to a position in the tree next to the WO that is most similar with respect to its features.

In one embodiment, a tree structure may be created for every feature separately. This means we have as many trees for classifying WOs as we have features defined. In the following, the use of one tree per feature will be discussed.

In another embodiment it is also possible to have only one overall tree for all possible features. In this case a similarity score over all features may be calculated and the tree may be built based on this similarity score.

In a tree, two similar work orders are close neighbors. This may be technically expressed by a metric based on the tree graph.

When using one tree per feature, i.e. single-feature tree, and when using one overall tree for multiple possible features, i.e. multi-feature tree, the similarity metric may then be defined as the height that should be traveled in the vertical direction between two work orders via the shortest path:

S(w, f)=The height to go through the feature graph of f from the current WO (w₀) to reach an arbitrary WO w.

Another possible metric of similarity may be the number of upward steps needed to take until a common branching point is reached.

New WOs are first classified by analyzing their features as indicated in the WO description and contextual information. With this information a location in the tree may be assigned to it and this means a similarity metric to each historical work order is available.

FT profiles inherit the features from the WO that the technician has executed. This means for example that if a FT has serviced a model of radio base station, the FT is skilled in that model. If certain equipment was used, the FT is then considered to be competent with this equipment. If the service was executed in a certain location, the FT is available in this location or region. All these skills could be indicated in FT profiles.

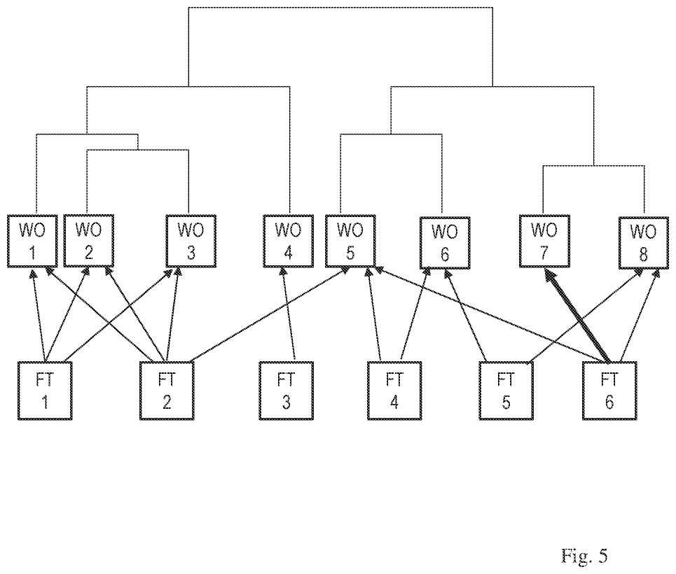

The FT profile of an individual FT may be linked to all the work orders the FT has executed. This is shown in FIG. 5.

The number of times a feature was worked with or the related skill was demonstrated serves as confidence metric. When using one tree per feature, the number of links from a FT to WOs may correspond to the number of times the FT has worked with that feature. The experience score of the FT with respect to a feature f is defined as:

E(f)=The number of links to WOs with feature f.

In a further embodiment, the success and performance of a FT may also be included when calculating the experience score. The success and performance of a FT with a WO may for example be a score number assigned to all links between the FT profile and the features of that WO. The experience score of feature f may be defined as:

$$E ( f ) = {\sum }_{all WO links} {W}_{f} \times {P}_{f}$$

Where W_{f} is the weight for feature f of an individual link between a WO and a profile of a FT, and P_{f} is the performance measurement of the corresponding WO, including the degree of completion.

As described above, FIG. 1 illustrates an overview of a procedure for allocating a FT, which procedure will now be further described with reference to various examples. A technician allocating system is provided that allocates a FT to solve a new WO. The FT with the best matched competence with the needs of the new WO may be allocated.

The technician allocation system analyses the new WO with respect to its feature set. The new WO may be assigned to clusters in the feature trees. A similarity score S(w, f) for the new WO with respect to a historical WO w, i.e. an old WO, may be calculated per feature. This will lead to a list per feature of similar historical WOs sorted by similarity.

There are FTs linked to each historical WO. The technician allocating system ranks FTs with respect to their experience and success with similar WOs. It assigns a matching score to each FT and may propose to allocate the FT with the highest score, of the FTs that are available.

The matching score M(f) per feature is calculated from the similarity score S(w, f) and the experience/success score E(f),

$$M ( f ) = {\sum }_{historical work orders w} S ( w , f ) \times E ( f )$$

In general, the matching score would be calculated over all historical WOs, but it is reasonable and more efficient to only use the most similar ones in this calculation. A reasonable number would be the 100 most similar historical WOs.

So far, the matching is done per feature. This means that for every feature, a best FT would be allocated. In a last step the technician allocating system will choose at least one FT. There are a number of different ways to do that:
a) Choose the field technician having the highest matching scores in most features.
b) Choose the field technician with the highest average matching score AM:

$$AM = \frac{{Σ}_{all features f} M ( f )}{Number of features}$$

c) Choose the field technician with the highest weighted average matching score AM. A weight is introduced that expresses the importance I(f) per feature,

$$AM = \frac{{Σ}_{all features f} M ( f ) \times I ( f )}{Number of features}$$

If the first choice FT is not available, the technician allocating system may then allocate the next best match and continue to do that until an available FT is found.

The technician allocating system may prefer the most experienced technicians. This is not always ideal, because less experienced technicians might need training and need to be preferred even if they are not the best match.

What they need to be trained on may be indicated as a subset of features. A bias vector or a bias function B(f) may also be introduced, which allows to set an additional weight per feature f. The bias vector or function B(f) may be used in the calculation of the overall average matching score AM as additional weight:

$$AM = \frac{{Σ}_{all features f} M ( f ) \times I ( f ) \times B ( f )}{Number of features}$$

The bias vector/function is personal for each FT. It may be changed over time to change the focus areas for a FT.

This Bias vector/function may be used for other purposes besides training. It may for example emphasis a geographical location.

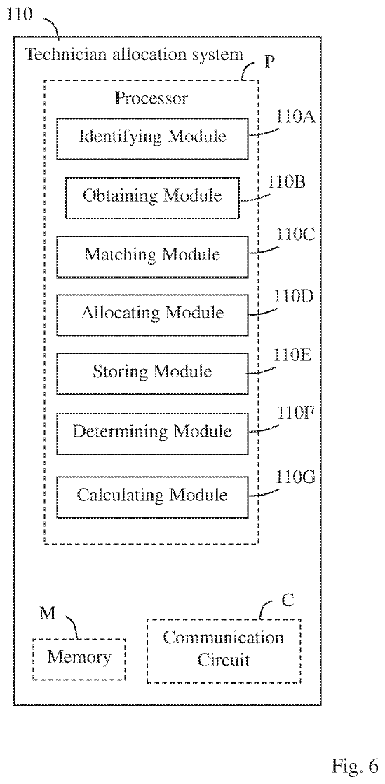

The block diagram in FIG. 6 illustrates a detailed but non-limiting example of how a technician allocating system 110 may be structured to bring about the above described solution and embodiments thereof. In this figure, the technician allocating system 110 may be configured to operate according to any of the examples and embodiments of employing the solution as described herein, where appropriate. The technician allocating system 110 is shown to comprise a processor “P”, a memory “M” and a communication circuit “C” with suitable equipment for transmitting and receiving information and messages in the manner described herein.

The communication circuit C in the technician allocating system 110 thus comprises equipment configured for communication using a suitable protocol for the communication depending on the implementation. The solution is however not limited to any specific types of messages or protocols.

The technician allocating system 110 is, e.g. by means of units, modules or the like, configured or arranged to perform at least some of the actions of the flow chart in FIG. 2 as follows.

The technician allocating system 110 is arranged to allocate a FT which technician allocation system 110 operates in a telecommunication network 100. The technician allocating system 110 is configured to identify features f₁ . . . fₙ of a received new WO to be executed on equipment in the telecommunication network 100. This operation may be performed by an identifying module 110A in the technician allocating system 110, as illustrated in action 200.

The technician allocating system 110 is also configured to obtain similarity scores for the identified features f₁ . . . fₙ, wherein the similarity scores are related to how similar the new WO is to previously executed old WOs with respect to the identified features, the old WOs having at least one of the features f₁ . . . fₙ. This operation may be performed by an obtaining module 110B, as illustrated in action 202.

The technician allocating system 110 is further configured to obtain for a set of FT candidates, an FT experience score for each FT candidate with respect to the identified features f₁ . . . fₙ. This operation may be performed by an obtaining module 110B in the technician allocating system 110, as illustrated in action 204.

The technician allocating system 110 is also configured to match the FT candidates with the features f₁ . . . fₙ for the new WO based on the obtained FT experience scores and the similarity scores. This operation may be performed by a matching module 110C, as illustrated in action 206.

The technician allocating system 110 is also configured to allocate at least one of the FTs for executing the new WO on said equipment, based on the matching. This operation may be performed by an allocating module 110D, as illustrated in action 208.

The technician allocating system 110 is further configured to after execution of the new WO by the at least one allocated FT, store information related to said execution in a database 120 as a basis for updating the FT experience score of the at least one allocated FT. This operation may be performed by a storing module 110E, as illustrated in action 208.

The technician allocating system 110 is further configured to when obtaining the FT experience score determine a weight factor of the features f₁ . . . fₙ indicating the number of times the FT has executed the old WO. This operation may be performed by a determining module 110F, as illustrated in action 300.

The technician allocating system 110 is further configured to when obtaining the FT experience score determine a performance factor for each FT candidate with respect to the features f₁ . . . fₙ, wherein the performance factor is related to a result when the old WO was executed by the FT. This operation may be performed by the determining module 110F, as illustrated in action 302.

The technician allocating system 110 is further configured to when obtaining the FT experience score calculate the FT experience score per feature based on the determined weight factor and performance factor. This operation may be performed by a calculating module 110G, as illustrated in action 304.

It should be noted that FIG. 6 illustrates various functional modules in the technician allocating system 110 and the skilled person is able to implement these functional modules in practice using suitable software and hardware equipment. Thus, the solution is generally not limited to the shown structure of the technician allocating system 110, and the functional modules therein may be configured to operate according to any of the features, examples and embodiments described in this disclosure, where appropriate.

The functional modules 110A-G described above may be implemented in the technician allocating system 110 by means of program modules of a computer program comprising code means which, when run by the processor P causes the technician allocating system 110 to perform the above-described actions and procedures. The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

The computer program may be carried by a computer program product in the technician allocating system 110 in the form of a memory having a computer readable medium and being connected to the processor P. The computer program product or memory M in the technician allocating system 110 thus comprises a computer readable medium on which the computer program is stored e.g. in the form of computer program modules or the like. For example, the memory M may be a flash memory, a Random-Access Memory (RAM), a Read-Only Memory (ROM) or an Electrically Erasable Programmable ROM (EEPROM), and the program modules could in alternative embodiments be distributed on different computer program products in the form of memories within the technician allocating system 110.

The solution described herein may be implemented in the technician allocating system 110 by a computer program comprising instructions which, when executed on at least one processor, cause the at least one processor to carry out the actions according to any of the above embodiments and examples, where appropriate. The solution may also be implemented at the technician allocating system 110 in a carrier containing the above computer program, wherein the carrier is one of an electronic signal, optical signal, radio signal, or computer readable storage medium.

While the solution has been described with reference to specific exemplifying embodiments, the description is generally only intended to illustrate the inventive concept and should not be taken as limiting the scope of the solution. For example, the terms “technician allocating system”, “equipment”, “field technician” and “work order” have been used throughout this disclosure, although any other corresponding entities, functions, and/or parameters could also be used having the features and characteristics described here. The solution is defined by the appended claims.

1. A method performed by a technician allocation system for allocating a field technician (FT) which technician allocation system operates in a telecommunication network, the method comprising:
identifying features f₁ . . . fₙ of a received new work order (WO) to be executed on equipment in the telecommunication network;
obtaining similarity scores for the identified features f₁ . . . fₙ, wherein the similarity scores are related to how similar the new WO is to previously executed old WOs with respect to the identified features, the old WOs having at least one of the features f₁ . . . fₙ;
obtaining for a set of FT candidates, an FT experience score for each FT candidate with respect to the identified features f₁ . . . fₙ;
matching the FT candidates with the features f₁ . . . fₙ for the new WO based on the obtained FT experience scores and the similarity scores; and
allocating at least one of the FTs for executing the new WO on said equipment, based on the matching.

2. The method according to claim 1, wherein the FT experience scores are dependent on the number of times the respective FT candidate has executed an old WO having at least one of the features f₁ . . . fₙ.

3. The method according to claim 1, wherein obtaining the FT experience score comprises:
determining a weight factor of the features f₁ . . . fₙ indicating the importance of the features f₁ . . . fₙ in the old WO;
determining a performance factor for each FT candidate with respect to the features f₁ . . . fₙ, wherein the performance factor is related to a result when the old WO was executed by the FT; and
calculating the FT experience score per feature based on the determined weight factor and performance factor.

4. The method according to claim 1, wherein the similarity score for the features f₁ . . . fₙ is obtained by comparing the new WO with old WOs having at least one of the identified features f₁ . . . fₙ in common.

5. The method according to claim 1 further comprises, after execution of the new WO by the at least one allocated FT, storing information related to said execution in a work force database as a basis for updating the FT experience score of the at least one allocated FT.

6. The method according to claim 1, wherein the allocating comprises selecting the FT(s) with the highest number of matching features f₁ . . . fₙ.

7. The method according to claim 1, wherein the allocating comprises selecting the FT(s) with the highest average matching of the features f₁ . . . fₙ.

8. The method according to claim 7 wherein the allocating comprises selecting the FT(s) with the highest weighted average matching of the features f₁ . . . fₙ.

9. The method according to claim 8, wherein the FT is allocated further based on a bias factor related to a need of training the FT.

10. The method according to claim 1, wherein the identified features f₁ . . . fₙ are related to at least some of: equipment needed, specific skills needed, location, geographic characteristics, software and/or hardware used in the equipment, number of users and site configuration.

11. A technician allocation system arranged to allocate a field technician (FT) which technician allocation system operates in a telecommunication network, the technician allocation system being configured to:
identify features f₁ . . . fₙ of a received new work order (WO) to be executed on equipment in the telecommunication network;
obtain similarity scores for the identified features f₁ . . . fₙ, wherein the similarity scores are related to how similar the new WO is to previously executed old WOs with respect to the identified features, the old WOs having at least one of the features f₁ . . . fₙ;
obtain for a set of FT candidates, an FT experience score for each FT candidate with respect to the identified features f₁ . . . fₙ;
match the FT candidates with the features f₁ . . . fₙ for the new WO based on the obtained FT experience scores and the similarity scores; and
allocate at least one of the FTs for executing the new WO on said equipment, based on the matching.

12. The technician allocation system according to claim 11, wherein the FT experience scores are dependent on the number of times the respective FT candidate has executed an old WO having at least one of the features f₁ . . . fₙ.

13. The technician allocation system according to claim 11, wherein when obtaining the FT experience score the technician allocation system being configured to comprise:
determine a weight factor of the features f₁ . . . fₙ indicating the number of times the FT has worked with at least one of the features f₁ . . . fₙ in the old WO;
determine a performance factor for each FT candidate with respect to the features f₁ . . . fₙ,
wherein the performance factor is related to a result when the old WO was executed by the FT; and
calculate the FT experience score per feature based on the determined weight factor and performance factor.

14. The technician allocation system according to claim 11, wherein the similarity score for the features f₁ . . . fₙ is obtained by comparing the new WO with old WOs having at least one of the identified features f₁ . . . fₙ in common.

15. The technician allocation system according to claim 11 being adapted to further comprise, after execution of the new WO by the at least one allocated FT, store information related to said execution in a work force database as a basis for updating the FT experience score of the at least one allocated FT.

16. The technician allocation system according to claim 11, wherein the allocating comprises selecting the FT(s) with the highest number of matching features f₁ . . . fₙ.

17. The technician allocation system according to claim 11, wherein the allocating comprises selecting the FT(s) with the highest average matching of the features f₁ . . . fₙ.

18. The technician allocation system according to claim 17 wherein the allocating comprises selecting the FT(s) with the highest weighted average matching of the features f₁ . . . fₙ.

19. The technician allocation system according to claim 18, wherein the FT is allocated further based on a bias factor related to a need of training the FT.

20. The technician allocation system according to claim 11, wherein the identified features f₁ . . . fₙ are adapted to be related to at least some of: equipment needed, specific skills needed, location, geographic characteristics, software and/or hardware used in the equipment, number of users and site configuration.

21-22. (canceled)
